(19) United States
(12) Patent Application Publication
(10) Pub. No.: US 2025/0061063 A1
(43) Pub. Date: Feb. 20, 2025

(54) SYSTEMS, METHODS, AND APPARATUS FOR A CACHE MANAGEMENT POLICY FOR MEMORY CACHES

(71) Applicant: Samsung Electronics Co., Ltd., Suwon-si (KR)

(72) Inventors: Luis Vitorio CARGNINI, San Jose, CA (US); Andrew Zhenwen CHANG, San Mateo, CA (US); Yitu WANG, Durham, NC (US); Mohammadreza SOLTANIYEH, Sunnyvale, CA (US); Dongyang LI, Milpitas, CA (US)

(21) Appl. No.: 18/793,746

(22) Filed: Aug. 2, 2024

Related U.S. Application Data
(60) Provisional application No. 63/532,897, filed on Aug. 15, 2023.

(51) Int. Cl. G06F 12/12

(52) U.S. Cl. CPC G06F 12/12

(57) ABSTRACT

A device may include memory media configured as cache media; and one or more circuits configured to perform operations including receiving memory access information, performing a mixture model analysis based on the memory access information to produce one or more scores, and updating the memory media based on the one or more scores. The memory media may include determining that at least one of the one or more scores is above a threshold and loading a portion of memory corresponding to the at least one of the one or more scores to the memory media. Updating the memory media may include determining that at least one of the one or more scores is below a threshold and removing a portion of memory corresponding to the at least one of the one or more scores from the memory media.

### REFERENCE TO RELATED APPLICATION

This application claims priority to, and the benefit of, U.S. Provisional Patent Application Ser. No. 63/532,897, filed on Aug. 15, 2023, which is incorporated by reference.

### TECHNICAL FIELD

This disclosure relates generally to memory caches, and more specifically to systems, methods, and apparatus for a cache management policy for memory caches.

### BACKGROUND

Storage devices may use a cache to populate data in faster memory, allowing for improved efficiency in retrieving data. Generally, the cache management policy determines how the storage device populates and/or replaces the cache with data.

The above information disclosed in this Background section is only for enhancement of understanding of the background of the invention and therefore it may contain information that does not constitute prior art.

### SUMMARY

In some aspects, the techniques described herein relate to a device, including memory media configured as cache media; and one or more circuits configured to perform operations including receiving memory access information; performing a mixture model analysis based on the memory access information to produce one or more scores; and updating the memory media based on the one or more scores. In some aspects, updating the memory media includes determining that at least one of the one or more scores is above a threshold; and loading a portion of memory corresponding to the at least one of the one or more scores to the memory media. In some aspects, updating the memory media includes determining that at least one of the one or more scores is below a threshold; and removing a portion of memory corresponding to the at least one of the one or more scores from the memory media. In some aspects, the memory access information is first access information, and wherein the one or more circuits is further configured to perform operations including: receiving second access information; and updating the mixture model analysis based on the second access information to produce the one or more scores. In some aspects, performing the mixture model analysis includes using an expectation-maximization algorithm on the memory access information, wherein the one or more scores correspond to a maximum a posteriori estimate based on the expectation-maximization algorithm.

In some aspects, the techniques described herein relate to a method including receiving memory access information; calculating, using on the memory access information, using a mixture model, one or more scores; and updating memory media based on the one or more scores. In some aspects, the memory access information includes at least one of address information and order of access information; and the at least one of address information and order of access information are input to the mixture model. In some aspects, the method further includes setting a threshold value; and comparing output of the mixture model with the threshold value to determine a distribution value. In some aspects, comparing the output of the mixture model includes calculating a first score based on a frequency value and second score from the mixture model; and comparing the first score with the threshold value. In some aspects, the threshold value relates to a size of the memory media. In some aspects, the techniques described herein relate to a method, wherein the mixture model is a Gaussian mixture model (GMM). In some aspects, calculating the one or more scores includes: training, in parallel, a first Gaussian and a second Gaussian. In some aspects, calculating the one or more stores includes using an expectation-maximization algorithm on the mixture model to calculate the one or more scores. In some aspects, the method further includes writing data to the memory media based on the one or more scores. In some aspects, the method further includes removing data from the memory media based on the one or more scores. In some aspects, the memory access information is first memory access information; and the method further includes receiving second memory access information; and calculating, using the second memory access information, the one or more scores.

In some aspects, the techniques described herein relate to a system, including: a host device including one or more applications; and a storage device including memory media, wherein the storage device is configured to perform operations including: determining memory access information corresponding to the one or more applications; training a mixture model using the memory access information; determining one or more memory locations based on the mixture model; and updating the memory media using the one or more memory locations. In some aspects, the memory access information includes address information and order of access information; and wherein the address information and order of access information are input to the mixture model. In some aspects, updating the memory media using the one or more memory locations includes: writing data to the memory media based on the one or more memory locations. In some aspects, updating the memory media using the one or more memory locations includes: removing data from the memory media based on the one or more memory locations.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a storage device scheme in accordance with example embodiments of the disclosure.

FIG. 2 illustrates another embodiment of a storage device scheme in accordance with example embodiments of the disclosure.

FIG. 3 illustrates an example method of populating memory media based on a Gaussian mixture model (GMM) in accordance with example embodiments of the disclosure.

FIG. 4 illustrates an example of output of a GMM analysis in accordance with embodiments of the disclosure.

FIG. 5 illustrates an example operating environment for populating memory media based on a mixture model in accordance with example embodiments of the disclosure.

FIG. 6 illustrates an example device for populating memory media based on a mixture model in accordance with example embodiments of the disclosure.

FIG. 7 illustrates an example flowchart of populating memory media based on a mixture model in accordance with example embodiments of the disclosure.

### DETAILED DESCRIPTION

A storage device may include memory media (e.g., cache media) and storage media. For example, cache media may include dynamic random access memory (DRAM) and the storage media may include not-AND (NAND) flash memory. Memory media is typically characterized as being faster than storage media (e.g., the latency of memory media is calculated in nanoseconds whereas storage media is calculated in microseconds). In some embodiments, the memory media may be used to store recently or frequently used data, allowing the data to be retrieved more quickly than using storage media. However, the size of the memory media may be relatively small compared to the size of the storage media. Thus, existing data on the memory media may be replaced when, e.g., loading data to the memory media (e.g., copying data from the storage media to the memory media). If the memory media is not populated efficiently (e.g., data that may be accessed may not be populated to or may be removed from and/or data that may not be accessed may remain on the memory media), the storage device may have a low cache hit rate, leading to longer latency on the storage device (e.g., the storage device may need to copy data from the storage media to the memory media to return data in response to a cache miss). In some embodiments, a cache management policy (or cache replacement policy) may be used to determine how data is populated (e.g., loaded and removed) on the memory media. In some embodiments, improving the efficiency of the cache management policy (e.g., populating the memory media to obtain more cache hits) may reduce latency, and improve the overall performance of the storage device.

A cache management policy may use various algorithms, such as least recently used (LRU), to populate the memory media. Some cache management policies may be based on machine learning using a neural network. Although a cache management policy based on a neural network may perform better than one using a LRU algorithm, training the neural network, depending on the size and complexity of the data, may take a long time to train and require significant computing resources, such as graphic processing unit (GPU) and/or hundreds of MBs of memory, to efficiently train the neural network. Furthermore, the cache management policy may not capture the relationship between certain memory access patterns and a host. Thus, embodiments of the present disclosure are directed to providing a cache management policy based on a Gaussian mixture model (GMM) using memory access patterns as input to the GMM. In some embodiments, using a GMM may consume fewer resources and may be faster to train than other machine learning algorithms. For example, in some embodiments, a training dataset may be created. The dataset may be a model trained using data collected when an application is being used. In some embodiments, the model may be input into a GMM maximum-likelihood computing unit. In some embodiments, the GMM maximum-likelihood computing unit may calculate the likelihood of a page being accessed using memory access patterns. In some embodiments, based on the likelihood of the page being accessed, the memory media may be populated with one or more pages of data.

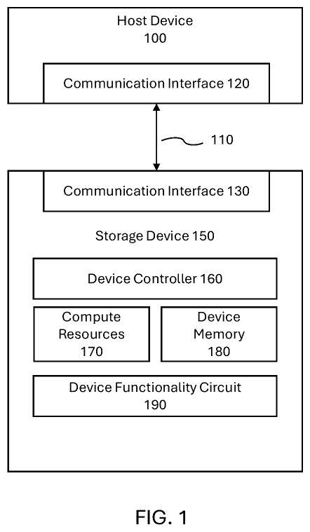

FIG. 1 illustrates an embodiment of a storage device scheme in accordance with example embodiments of the disclosure. The embodiment illustrated in FIG. 1 may include one or more host devices 100 and one or more storage devices 150 configured to communicate using one or more communication connections 110.

In some embodiments, a host device 100 may be implemented with any component or combination of components that may utilize one or more features of a storage device 150. For example, a host may be implemented with one or more of a server, a storage node, a compute node, a central processing unit (CPU), a workstation, a personal computer, a tablet computer, a smartphone, and/or the like, or multiples and/or combinations thereof.

In some embodiments, a storage device 150 may include a communication interface 130, memory 180 (some or all of which may be referred to as device memory), one or more compute resources 170 (which may also be referred to as computational resources), a device controller 160, and/or a device functionality circuit 190. In some embodiments, the device controller 160 may control the overall operation of the storage device 150 including any of the operations, features, and/or the like, described herein. For example, in some embodiments, the device controller 160 may parse, process, invoke, and/or the like, commands received from the host devices 100.

In some embodiments, the device functionality circuit 190 may include any hardware to implement the primary function of the storage device 150. For example, the device functionality circuit 190 may include storage media such as magnetic media (e.g., if the storage device 150 is implemented as a hard disk drive (HDD) or a tape drive), solid-state media (e.g., one or more flash storage devices), optical media, and/or the like. For instance, in some embodiments, a storage device may be implemented at least partially as a solid-state drive (SSD) based on NAND flash memory, persistent memory (PMEM) such as cross-gridded nonvolatile memory, memory with bulk resistance change, phase change memory (PCM), or any combination thereof. In some embodiments, the device controller 160 may include a media translation layer such as a flash translation layer (FTL) for interfacing with one or more flash storage devices. In some embodiments, the storage device 150 may be implemented as a computational storage drive, a computational storage processor (CSP), and/or a computational storage array (CSA).

As another example, if the storage device 150 is implemented as an accelerator, the device functionality circuit 190 may include one or more accelerator circuits, memory circuits, and/or the like.

The compute resources 170 may be implemented with any component or combination of components that may perform operations on data that may be received, stored, and/or generated at the storage device 150. Examples of compute engines may include combinational logic, sequential logic, timers, counters, registers, state machines, complex programmable logic devices (CPLDs), field programmable gate arrays (FPGAs), application-specific integrated circuits (ASICs), embedded processors, microcontrollers, CPUs such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

In some embodiments, the memory 180 may be used, for example, by one or more of the compute resources 170 to store input data, output data (e.g., computation results), intermediate data, transitional data, and/or the like. The memory 180 may be implemented, for example, with volatile memory such as dynamic random-access memory (DRAM), static random-access memory (SRAM), and/or the like, as well as any other type of memory such as nonvolatile memory.

In some embodiments, the memory 180 and/or compute resources 170 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 180 and/or compute resources 170. In some embodiments, software, instructions, programs, code, and/or the like, may be downloaded, uploaded, sideloaded, pre-installed, built-in, and/or the like, to the memory 180 and/or compute resources 170. In some embodiments, the storage device 150 may receive one or more instructions, commands, and/or the like, to select, enable, activate, execute, and/or the like, software, instructions, programs, code, and/or the like. Examples of computational operations, functions, and/or the like, that may be implemented by the memory 180, compute resources 170, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for AI, ML, neural networks, and/or the like.

In some embodiments, a communication interface 120 at a host device 100, a communication interface 130 at a storage device 150, and/or a communication connection 110 may implement, and/or be implemented with, one or more interconnects, one or more networks, a network of networks (e.g., the internet), and/or the like, or a combination thereof, using any type of interface, protocol, and/or the like. For example, the communication connection 110, and/or one or more of the interfaces 120 and/or 130 may implement, and/or be implemented with, any type of wired and/or wireless communication medium, interface, network, interconnect, protocol, and/or the like including Peripheral Component Interconnect Express (PCIe), NVMe, NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 110 may include one or more switches, hubs, nodes, routers, and/or the like.

In some embodiments, a storage device 150 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the storage devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a storage device 150 may be implemented with any device that may include, or have access to, memory, storage media, and/or the like, to store data that may be processed by one or more compute resources 170. Examples may include memory expansion and/or buffer devices such as CXL type 2 and/or CXL type 3 devices, as well as CXL type 1 devices that may include memory, storage media, and/or the like.

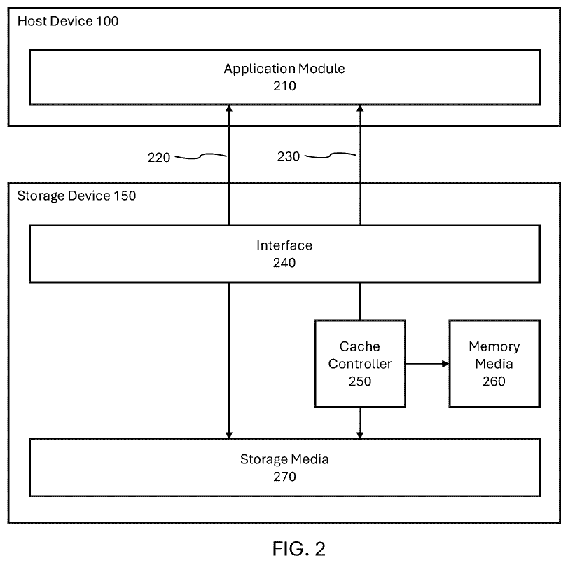

FIG. 2 illustrates another embodiment of a storage device scheme in accordance with example embodiments of the disclosure. The elements illustrated in FIG. 2 may be similar elements to those illustrated in FIG. 1 in which similar elements may be indicated by reference numbers ending in, and/or containing, the same digits, letters, and/or the like. In some embodiments, the host device 100 may include an application module 210; and the memory device 150 may include an interface 240, cache controller 250, memory media 260, and/or storage media 270. In some embodiments, the interface 240 and/or cache controller 250 may be implemented on one or more circuits of the memory device 150. In some embodiments, the one or more circuits may include one or more FPGAs, ASICs, and/or SOCs.

In some embodiments, the memory media 260 may be relatively fast memory such as DRAM and the storage media 270 may be slower non-volatile memory, such as NAND flash memory. In some embodiments, the memory media 260 may be used as a cache to store frequently accessed data in the faster memory. In some embodiments, the application module 210 may run an application that may access the storage device 150 (e.g., send a request to the storage device 150). For example, the application module 210 may request data from the storage device 150 by using an I/O block access request 220. In particular, the application module 210 may use a I/O block access request 220 to retrieve data from the storage media 270. In some embodiments, the application module 210 may use a memory access request, received at the cache controller 250, to retrieve data from the memory media 260. In particular, in response to receiving a memory access request 230, the memory device 150 may send a request to the cache controller 250 to check the memory media 260 for data corresponding to the request. In some embodiments, in response to a cache hit (e.g., the data is found on the memory media 260), the data may be returned from the memory media 260. In some embodiments, in response to a cache miss (e.g., the data is not found on the memory media 260), the cache controller 250 may copy the data from the storage media 270 to the memory media 260 and return the data from the memory media 260. In some embodiments, the cache controller 250 may also load and remove data from the memory media 260 in the background. In this way, the cache controller 250, using a cache management policy, may play a role in managing the replacement of data on the memory media 260 and facilitating memory accesses from the host device 100.

In some embodiments, the cache controller 250 may implement a cache management policy (e.g., cache replacement policy) using a GMM for a neural network. In some embodiments, using the cache management policy, the memory media 260 may be populated more efficiently allowing for less latency, and thus, improving the performance of the storage device 150.

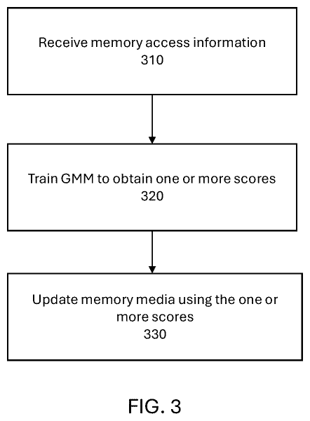

FIG. 3 illustrates a cache management policy training scheme using a GMM in accordance with embodiments of the disclosure. The embodiment illustrated in FIG. 3 may be implemented, for example, using any of the embodiments illustrated in FIG. 1 and/or FIG. 2.

At operation 310, memory access information (e.g., physical address patterns) may be received. For example, one or more circuits of a storage device may receive physical address patterns from the memory media and/or storage media. In some embodiments, the physical address patterns may alternatively be received by a host, training device, or other system to generate a mixture model to be used by the storage device. In some embodiments, the physical address patterns may include data such as the physical addresses on a storage device that are accessed by, e.g., a host or application, and the order of access (e.g., timestamp) of the accesses to the storage device. In some embodiments, the physical address patterns may correspond to one or more applications. For example, in some embodiments, as the application is being executed, the physical address patterns corresponding to the accesses by the application may be received. In some embodiments, the memory access information may alternatively be for a usage scenario. For example, as one or more applications are run in sequence or in parallel for a given usage scenario, the memory access information may be received for that scenario.

At operation 320, one or more scores may be calculated based on the memory access information. For example, the memory access information may be input to a GMM to produce one or more clusters. In some embodiments, the clusters may represent areas of higher likelihood of memory access. In some embodiments, the one or more scores may be generated that correspond to the clusters for one or more memory addresses.

In some embodiments, the GMM may be pre-trained using the memory access information. For example, in some embodiments, the GMM may initially be generated using the memory access information. In some embodiments, the GMM may be pre-trained using other data. For example, the GMM may be trained with seed data or other training data. In some embodiments, multiple iterations of the GMM may be run until a convergence threshold is achieved. For example, as more iterations of the GMM are run, the data may converge around one or more clusters. However, there may be a trade-off between the accuracy of the results and the number of iterations. In some embodiments, if too few iterations are run, the GMM may be calculated faster but the results may not be very accurate. In some embodiments, if too many iterations are run, the GMM may take more time to calculate but provide more accurate results. In some embodiments, a threshold may be used to determine the accuracy of the results. For example, a threshold may be set by a host indicating a desired accuracy of the cache data. In some embodiments, the GMM may be pre-processed. For example, the first 20 percent and/or last 10 percent of the memory access data may initially be removed as input to the GMM.

In some embodiments, a two-dimensional GMM may be used. In some embodiments, the memory access information may include spatial information and temporal information that may be input to the GMM. For example, address information (e.g., physical addresses of memory accesses) and order of access information may be input to the GMM.

In some embodiments, the Gaussian functions may be mixed using normalized weights to obtain a score for the likelihood of each physical address. In some embodiments, an expectation-maximization (EM) algorithm may be used. For example, the EM algorithm may produce maximum a posteriori (MAP) areas of the GMM that may indicate areas of higher concentration of clustered data. In some embodiments, using the clustered data, scores for portions of memory may be calculated.

In some embodiments, the GMM may be trained using the EM algorithm. For example, the probability of the memory access information belonging to a Gaussian function may be calculated based on Bayes' theorem. In some embodiments, the GMM parameters may be updated to better represent the memory access patterns. In some embodiments, for each iteration, the change in the maximum likelihood estimate may be checked. In some embodiments, if the change is below a threshold, then the parameter may be saved. In some embodiments, the iterations of the EM algorithm may stop when the lower bound average gains are below a pre-defined convergence threshold. For example, the default threshold may be 1e-3. In some embodiments, the threshold may be 1e-4.

At operation 330, the memory media may be updated based on the one or more scores. In some embodiments, the one or more scores may be compared with a threshold value. In some embodiments, if the one or more scores is above the threshold value, the one or more circuits may use the address corresponding to the score to update the memory media. For example, in some embodiments, if the address is not found on the memory media, the region of memory corresponding to the address may be added to the memory media. In some embodiments, if the address is found on the memory media, it may not be a candidate for replacement on the memory media. In some embodiments, if the score is below the threshold, the region of memory corresponding to the address may be removed from the memory media.

In some embodiments, a page size may be 4 KB. In some embodiments, the cache replacement size may also be 4 KB. Thus, the memory media may be updated at a size of a page. However, it is within the scope of the disclosure to use other sizes as well. In some embodiments, a score of the one or more scores may correspond to a page. Thus, for each page on the storage device, a score may be assigned to determine the likelihood of future access. In some embodiments, a page may be given a score by the GMM. In some embodiments, an address or address range may be given a score by the GMM.

In some embodiments, when the cache hit rate is low, the GMM may be retrained. In some embodiments, the GMM may be retrained until the cache hit rate reaches a threshold. In some embodiments, the cache hit rate may be checked at some interval to ensure that the memory media is being populated efficiently.

In some embodiments, the threshold value for the one or more scores may be set by a host. For example, in some embodiments, if the host determines that the cache may be populated with a high likelihood of being accessed, the threshold may be set to a high value. In some embodiments, if the host determines that the cache may be populated with more data, the threshold may be set to a lower value. In some embodiments, the threshold value may be adjusted based on the cache hit rate or other criteria. For example, if the cache hit rate is low, the threshold value may be adjusted upward, e.g., if the data in the cache is not being accessed. However, if the cache is not being populated fully, the threshold may be adjusted downward to populate more data to the cache. In some embodiments, the threshold may be generated from the training dataset.

In some embodiments, based on a threshold value, regions of memory with a score higher than the threshold value may be loaded and/or retained in the memory media. In some embodiments, regions of memory with scores below the threshold value may be removed from the memory media. In some embodiments, to determine a portion of memory to be removed in the memory media, the scores may be ordered, and the lowest scores may be removed. Thus, the cache may be populated with regions of memory with a higher likelihood of future use.

In some embodiments, based on the one or more scores from the GMM, more frequently accessed pages may be stored in the memory media, and less frequently accessed pages may be removed. In some embodiments, by populating memory media with data that has a higher predicted future use, cache hits may be increased, thereby decreasing the latency and increasing the performance of the memory device.

In some embodiments, other data may be used as input to the GMM. For example, the GMM may use storage, memory, access time, physical location, read time, write time, round trip time access, and amount of data available, among others.

In some embodiments, the GMM may be implemented on hardware. For example, the GMM may be implemented on one or more circuits (e.g., FPGA) of the storage device.

In some embodiments, the GMM may be trained using a package such as sklearn.mixture.gaussianmixture.

In some embodiments, the ground truth (e.g., information that is true or assumed to be true) may correspond to the top-k frequencies from the testing dataset. In some embodiments, the score may correspond to the top k scores from the data set. In some embodiments, the accuracy may be equal to the union of the ground truth and GMM score.

In some embodiments, the cache management policy model may be warmed up by analyzing the physical address access pattern of the application, adjusting the parameters of the GMM, and loading the finalized cache management policy model in the storage device.

In some embodiments, the GMM may be updated, e.g., when the applications change. For example, as long as the model works for an application, the model may not be changed. However, in some embodiments, when the applications change, the model may no longer work, and the GMM may be updated to account for the new application. In some embodiments, the GMM may be retrained for the new application.

In some embodiments, the cache hit rates may be monitored. In some embodiments, when the cache hit rates fall below a threshold, the GMM may be re-trained. In some embodiments, to retrain the data, a smaller subset of memory access patterns may be used. In some embodiments, the training may only retrain the parameters used for the GMM. In some embodiments, the training to generate the parameters may be done offline.

In some embodiments, data loaded to the memory media using the GMM and data loaded to the memory media through another operation may be distinguished. In some embodiments, the cache hit rate for data loaded to the memory media using the GMM may be monitored. In some embodiments, feedback may be given to the host indicating the success of the GMM in order for the host to make adjustments to, for example, the threshold value, using the feedback. In some embodiments, an interface may be provided to provide the feedback. In some embodiments, the host may use the cache hit rate to make adjustments to the threshold value.

In some embodiments, the confidence level may be based on the size of the memory media. For example, the threshold value may be based on how large the memory media is. In some embodiments, the GMM may be applied to different cache associativity. For example, the cache associativity may be direct mapped, n-way set associative, or fully associative. In some embodiments, if the memory media is directly mapped and the memory is, e.g., 2 PB in size, the hash table maintained by the cache controller may be large. However, the direct mapped cache may be based on the GMM score and the data address may be given an address corresponding to the score.

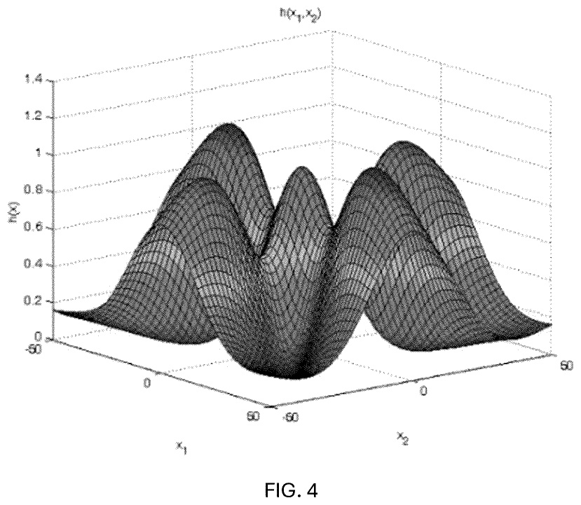

FIG. 4 illustrates an example of output of a GMM analysis in accordance with embodiments of the disclosure. For example, x1 may correspond order of access and x2 may correspond to the physical addresses. As illustrated in FIG. 4, the GMM may generate areas of distribution for the memory. In some embodiments, the areas of memory may be clustered to the mean of the distribution. In some embodiments, the data to pre-train the GMM may be generated by the host.

In some embodiments, the dataset for the GMM may contain multiple Gaussians (e.g., a mixture of the Gaussians). In some embodiments, each peak may represent a different Gaussian distribution or cluster in the dataset. In some embodiments, a mean and covariance may be used for the data points. In some embodiments, the distribution may be generated using the mean and covariance,

In some embodiments, an initial number of clusters may be determined. For example, FIG. 4 illustrates 5 clusters. In some embodiments, mean, covariance, and weight parameters for a cluster may be determined.

In some embodiments, an EM algorithm may be used to calculate the GMM. In some embodiments, the probability of each data point belonging to each distribution may be calculated. In some embodiments, the likelihood function may be evaluated using the calculated parameters. In some embodiments, the mean, covariance, and weight parameters may be updated. In some embodiments, the mean, covariance, and weight parameters may continue to be updated until the model converges.

In some embodiments, the mean, covariance, and weight parameters may be initialized. For example, the mean (μ) and covariance (δ) may be initialized randomly. In some embodiments, the weight (mixing coefficients) (α) may initially be equal for all clusters.

In some embodiments, the scores for the data may be calculated using the current parameters of the model. In some embodiments, conditional probability, e.g., Bayes theorem, may be used. In some embodiments, the scores are used to update the parameters of the GMM. In some embodiments, the process may be repeated until the algorithm converges, e.g., the parameters may not change significantly between iterations. In some embodiments, the host may determine when the GMM converges. For example, a threshold may be used to determine when the GMM converges. In some embodiments, the host may determine the threshold based on the host's requirements. For example, if the host chooses a high threshold, the GMM will converge sooner but the results may not be as accurate as with a lower threshold.

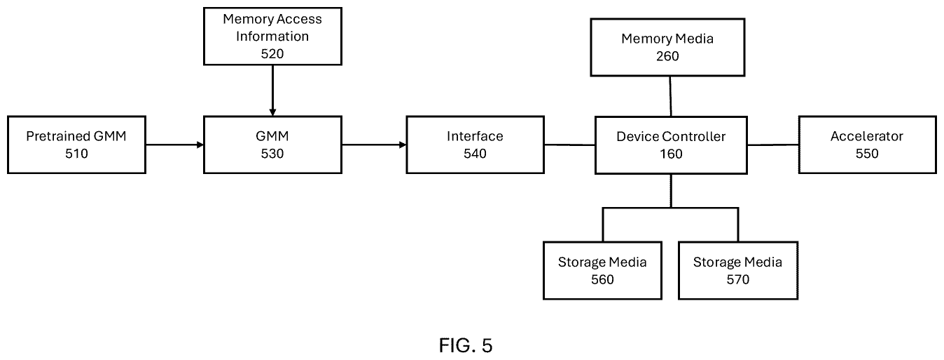

FIG. 5 illustrates an example operating environment for populating memory media based on a mixture model in accordance with example embodiments of the disclosure. The elements illustrated in FIG. 5 may be similar elements to those illustrated in FIG. 1 and/or FIG. 2 in which similar elements may be indicated by reference numbers ending in, and/or containing, the same digits, letters, and/or the like. The embodiment in FIG. 5 may include a pretrained mixture model (e.g., GMM) 510, a memory access information 520, mixture model (e.g., GMM) 530, an interface 540, an accelerator circuit 550, and/or storage media 560 and 570.

In some embodiments, the pretrained GMM 510 may be pretrained using training data. In some embodiments, the training data may represent data that will likely be accessed by an application. In some embodiments, the pretrained GMM 510 may be used to generate the GMM 530. For example, using the memory access information 520, the pretrained GMM 510 may be used to generate the GMM 530.

In some embodiments, the interface 540 may allow the host to communicate with the storage device. In some embodiments, the accelerator circuit 550 may be configured to perform specific functions more efficiently than an application running on a general-purpose CPU. In some embodiments, the storage media 560 and 570 may be storage media 270 in FIG. 2. In some embodiments, scores from the GMM 530 may be used to populate the memory media 260. For example, the device controller 160 may include a cache controller that implements a cache management policy using the GMM 530. In some embodiments, based on the scores from the GMM 530, the cache controller may copy data from storage media 560 and 570 to the memory media 260 and/or remove data from the memory media 260.

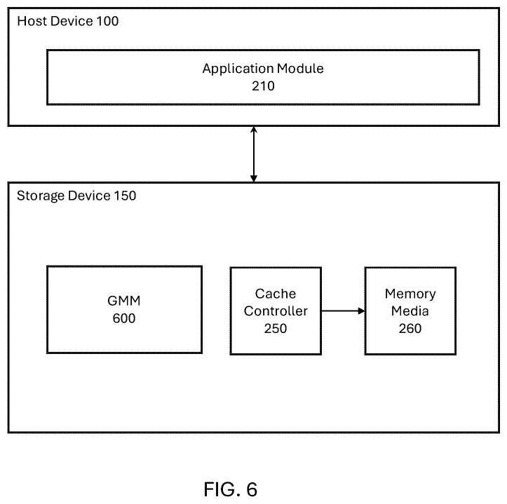

FIG. 6 illustrates an example device for populating memory media based on a mixture model in accordance with example embodiments of the disclosure. The elements illustrated in FIG. 6 may be similar elements to those illustrated in FIG. 2 in which similar elements may be indicated by reference numbers ending in, and/or containing, the same digits, letters, and/or the like. In some embodiments, the storage device 150 may include a GMM analysis module 600. In some embodiments, the GMM analysis module 600 may train the GMM and send the scores to the cache controller 250. Any of the described steps above may performed on the GMM analysis module 600. In some embodiments, the steps may be performed outside the GMM analysis module 600 and the GMM analysis module 600 may use the data to pass the scores to the cache controller 250. Although FIG. 6 illustrates the GMM analysis module 600 as being separate from the cache controller 250, it may not be a separate component and may be part of the cache controller 250.

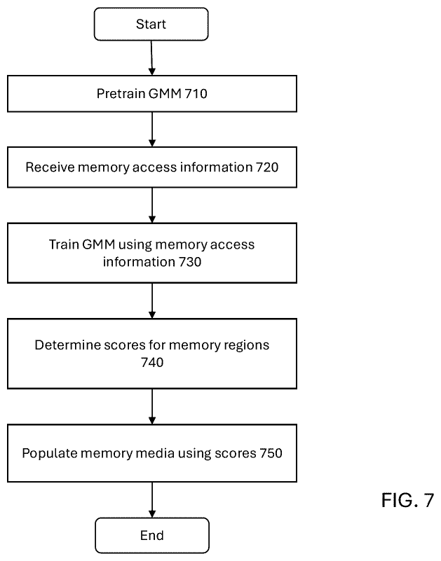

FIG. 7 illustrates an example flowchart of populating memory media based on a mixture model in accordance with example embodiments of the disclosure. The embodiment illustrated in FIG. 3 may be implemented, for example, using any of the embodiments illustrated in FIG. 1, FIG. 2, FIG. 6, and/or FIG. 6.

At operation 710, the GMM may be pre-trained. In some embodiments, the GMM may receive, e.g., seed data. In some embodiments, using the seed data, the GMM can be run to obtain one or more clusters. In some embodiments, an application may be run to obtain the seed data. In some embodiments, the seed data will be related to the operation of an application or a usage situation on a host.

At operation 720, the memory access information may be received. In some embodiments, the memory access information may include memory address information and order of access information. In some embodiments, other information may be included in the memory access information.

At operation 730, the GMM may be trained using the memory access information. In some embodiments, the parameter for the GMM may be pretrained. Thus, using the memory access information, the GMM may be trained. In some embodiments, an EM algorithm may be used to train the GMM. In some embodiments, multiple iterations of the GMM may be performed until the GMM reaches a threshold.

At operation 740, scores may be determined for memory regions using the GMM. In some embodiments, the EM algorithm may be used to determine scores for the memory regions. For example, the data for the GMM may be clustered. In some embodiments, higher scores may represent areas of higher likelihood of data being accessed in the cache.

At operation 750, the memory media may be populated using the scores. For example, a threshold value may be used to determine whether to populate the memory media with the region of memory corresponding to the score. In some embodiments, if the score for a memory region is above the threshold value, the data may be copied from the storage media to the memory media, or, if the data was already in the memory media, may be retained in the memory media. In some embodiments, if the score for a region of memory was below the threshold value, the data corresponding to the region of memory may be removed from the memory media. In some embodiments, if the score for a region of memory is below the threshold, the data may be retained until the cache does not have available space to load new data. In other words, in some embodiments, data is not removed until the memory media needs free space to load new data. In some embodiments, the scores may be ordered, and the data may be removed in order until the memory media has available space.

In some embodiments, using two dimensions, e.g., spatial (physical page indices) and temporal (order of access) information of memory requests can be incorporated for a GMM. In some embodiments, using a GMM for a cache management policy architecture can remove the necessity of keeping scores or counters, e.g., LRU, LRR. In some embodiments, the likelihood of memory access can be calculated on the go. In some embodiments, compared with a prior cache policy algorithm, using GMM can use much fewer parameters (<10 KB), which is feasible on device memory. In some embodiments, training the GMM from scratch can be much faster than training neural networks, e.g., LSTM and transformer. In some embodiments, the GMM can be adapted on the fly without needing to retrain the entire system in. production environment, e.g., MAP. In some embodiments, a GMM allows it to be shown in every step of the math where there is an issue. In some embodiments, the main models can be updated in a production environment. In some embodiments, the GMM can keep MAP samples to re-update at any given time with the new mixture model. In some embodiments, the GMM may be continuously calculated. In some embodiments, the GMM can be trained with multiple datasets and the traces of sampling can be combined from flows in a single model. In some embodiments, the GMM can be fit to any user or customer, with any dataflow requirements, despite its uniqueness, with the same math set in place. In some embodiments, the model can be upgraded, and the number of features used at a later time with minimal changes to a SoC or FPGA.

In some embodiments, a dataset is created. In some embodiments, the GMM may be trained by the traces collected from real applications. In some embodiments, the model may be trained using cross-validation. In some embodiments, with the parameters acquired, the model can be fed into a hard-macro implementation of the GMM maximum-likelihood computing unit. In some embodiments, on every request to the device, the unit may calculate the likelihood of the page access being in the hot zone or not. In some embodiments, there can be an initial cold-start until the cache is filled/utilized. Then, in some embodiments, based on ML for each access, the model can be used to decide the prefetch sequence. In some embodiments, the model can be used to decide the eviction, choose an eviction, or replace the cache address with a lower likelihood of pertaining to a hot zone of the memory instead of keeping an LRU score per cache line in each set. In some embodiments, as the trained model is fed into the system, there can be a secondary unit that can use MAP to run an update of the model in case a new flow is introduced into the system or the cache performance degrades due to an unexpected flow.

In some embodiments, a tensorflow or deep neural networks can be used.

In the embodiments described herein, the operations are example operations and may involve various additional operations not explicitly illustrated. In some embodiments, some of the illustrated operations may be omitted. In some embodiments, one or more of the operations may be performed by components other than those illustrated herein. Additionally, in some embodiments, the temporal order of the operations may be varied. Moreover, the figures are not necessarily drawn to scale.

In some embodiments, using a GMM for a cache management policy may enable efficient memory management by utilizing the GMM to analyze memory access patterns and optimize memory storage. In some embodiments, the GMM training process may enhance the system's ability to predict future memory access behavior, leading to improved memory utilization and performance. In some embodiments, by updating memory media according to the obtained scores, the method may facilitate adaptive memory allocation strategies tailored to specific usage patterns, thereby enhancing overall system efficiency and responsiveness.

The principles disclosed herein have independent utility and may be embodied individually, and not every embodiment may utilize every principle. However, the principles may also be embodied in various combinations, some of which may amplify the benefits of the individual principles in a synergistic manner.

In some embodiments, the latency of a storage device may refer to the delay between a storage device and the processor in accessing memory. Furthermore, latency may include delays caused by hardware such as the read-write speeds to access a storage device, and/or the structure of an arrayed storage device producing individual delays in reaching the individual elements of the array. For example, a first storage device in the form of DRAM may have a faster read/write speed than a second storage device in the form of a NAND device. Furthermore, the latency of a storage device may change over time based on conditions such as the relative network load, as well as performance of the storage device over time, and environmental factors such as changing temperature influencing delays on the signal path.

Although some example embodiments may be described in the context of specific implementation details such as a processing system that may implement a NUMA architecture, storage devices, and/or pools that may be connected to a processing system using an interconnect interface and/or protocol CXL, and/or the like, the principles are not limited to these example details and may be implemented using any other type of system architecture, interfaces, protocols, and/or the like. For example, in some embodiments, one or more storage devices may be connected using any type of interface and/or protocol including Peripheral Component Interconnect Express (PCIe), Nonvolatile Memory Express (NVMe), NVMe-over-fabric (NVMe oF), Advanced extensible Interface (AXI), Ultra Path Interconnect (UPI), Ethernet, Transmission Control Protocol/Internet Protocol (TCP/IP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, and/or the like, or any combination thereof. In some embodiments, an interconnect interface may be implemented with one or more memory semantic and/or memory coherent interfaces and/or protocols including one or more CXL protocols such as CXL.mem, CXL.io, and/or CXL.cache, Gen-Z, Coherent Accelerator Processor Interface (CAPI), Cache Coherent Interconnect for Accelerators (CCIX), and/or the like, or any combination thereof. Any of the storage devices may be implemented with one or more of any type of storage device interface including DDR, DDR2, DDR3, DDR4, DDR5, LPDDRX, Open Memory Interface (OMI), NVLink, High Bandwidth Memory (HBM), HBM2, HBM3, and/or the like.

In some embodiments, any of the storage devices, memory pools, hosts, and/or the like, or components thereof, may be implemented in any physical and/or electrical configuration and/or form factor such as a free-standing apparatus, an add-in card such as a PCIe adapter or expansion card, a plug-in device, for example, that may plug into a connector and/or slot of a server chassis (e.g., a connector on a backplane and/or a midplane of a server or other apparatus), and/or the like. In some embodiments, any of the storage devices, memory pools, hosts, and/or the like, or components thereof, may be implemented in a form factor for a storage device such as 3.5 inch, 2.5 inch, 1.8 inch, M.2, Enterprise and Data Center SSD Form Factor (EDSFF), NF1, and/or the like, using any connector configuration for the interconnect interface such as a SATA connector, SCSI connector, SAS connector, M.2 connector, U.2 connector, U.3 connector, and/or the like. Any of the devices disclosed herein may be implemented entirely or partially with, and/or used in connection with, a server chassis, server rack, dataroom, datacenter, edge datacenter, mobile edge datacenter, and/or any combinations thereof. In some embodiments, any of the storage devices, memory pools, hosts, and/or the like, or components thereof, may be implemented as a CXL Type-1 device, a CXL Type-2 device, a CXL Type-3 device, and/or the like.

In some embodiments, any of the functionality described herein, including, for example, any of the logic to implement tiering, device selection, and/or the like, may be implemented with hardware, software, or a combination thereof including combinational logic, sequential logic, one or more timers, counters, registers, and/or state machines, one or more CPLDs, FPGAS, ASICS, CPUs such as CISC processors such as x86 processors and/or RISC processors such as ARM processors, GPUs, NPUs, TPUs and/or the like, executing instructions stored in any type of memory, or any combination thereof. In some embodiments, one or more components may be implemented as a system-on-chip (SOC).

In this disclosure, numerous specific details are set forth in order to provide a thorough understanding of the disclosure, but the disclosed aspects may be practiced without these specific details. In other instances, well-known methods, procedures, components, and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” may include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

The term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), SoC, an assembly, and so forth. Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, e.g., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

While certain exemplary embodiments have been described and shown in the accompanying drawings, it should be understood that such embodiments merely illustrative, and the scope of this disclosure is not limited to the embodiments described or illustrated herein. The invention may be modified in arrangement and detail without departing from the inventive concepts, and such changes and modifications are considered to fall within the scope of the following claims.

1. A device, comprising:
memory media configured as cache media; and
one or more circuits configured to perform operations comprising:
receiving memory access information;
performing a mixture model analysis based on the memory access information to produce one or more scores; and
updating the memory media based on the one or more scores.

2. The device of claim 1, wherein updating the memory media comprises:
determining that at least one of the one or more scores is above a threshold; and
loading a portion of memory corresponding to the at least one of the one or more scores to the memory media.

3. The device of claim 1, wherein updating the memory media comprises:
determining that at least one of the one or more scores is below a threshold; and
removing a portion of memory corresponding to the at least one of the one or more scores from the memory media.

4. The device of claim 1, wherein the memory access information is first access information, and wherein the one or more circuits is further configured to perform operations comprising:
receiving second access information; and
updating the mixture model analysis based on the second access information to produce the one or more scores.

5. The device of claim 1, wherein performing the mixture model analysis comprises using an expectation-maximization algorithm on the memory access information, wherein the one or more scores correspond to a maximum a posteriori estimate based on the expectation-maximization algorithm.

6. A method comprising:
receiving memory access information;
calculating, using on the memory access information, using a mixture model, one or more scores; and
updating memory media based on the one or more scores.

7. The method of claim 6,
wherein the memory access information comprises at least one of address information and order of access information; and
wherein the at least one of address information and order of access information are input to the mixture model.

8. The method of claim 6, wherein the method further comprises:
setting a threshold value; and
comparing output of the mixture model with the threshold value to determine a distribution value.

9. The method of claim 8, wherein comparing the output of the mixture model comprises:
calculating a first score based on a frequency value and second score from the mixture model; and
comparing the first score with the threshold value.

10. The method of claim 8, wherein the threshold value relates to a size of the memory media.

11. The method of claim 6, wherein the mixture model is a Gaussian mixture model (GMM).

12. The method of claim 11, wherein calculating the one or more scores comprises:
training, in parallel, a first Gaussian and a second Gaussian.

13. The method of claim 6, wherein calculating the one or more scores comprises using an expectation-maximization algorithm on the mixture model to calculate the one or more scores.

14. The method of claim 6, further comprising:
writing data to the memory media based on the one or more scores.

15. The method of claim 6, further comprising:
removing data from the memory media based on the one or more scores.

16. The method of claim 6, wherein the memory access information is first memory access information; and wherein the method further comprises:
receiving second memory access information; and
calculating, using the second memory access information, the one or more scores.

17. A system, comprising:
a host device comprising one or more applications, and
a storage device comprising memory media, wherein the storage device is configured to perform operations comprising:
determining memory access information corresponding to the one or more applications;
training a mixture model using the memory access information;
determining one or more memory locations based on the mixture model; and
updating the memory media using the one or more memory locations.

18. The system of claim 17, wherein the memory access information comprises address information and order of access information; and wherein the address information and order of access information are input to the mixture model.

19. The system of claim 17, wherein updating the memory media using the one or more memory locations comprises:
writing data to the memory media based on the one or more memory locations.

20. The system of claim 17, wherein updating the memory media using the one or more memory locations comprises:
removing data from the memory media based on the one or more memory locations.
